(19) United States
(12) Patent Application Publication
(10) Pub. No.: US 2011/0090515 A1
(43) Pub. Date: Apr. 21, 2011

(54) Optical Sensing System

(75) Inventor: Remi Bruno Hasenohr, Paris (FR)

(73) Assignee: SKILLCLASS LIMITED, Road Town (VG)

(21) Appl. No.: 12/630,108

(22) Filed: Dec. 3, 2009

(30) Foreign Application Priority Data
Oct. 16, 2009 (TW) 098135061

(51) Int. Cl. G01B 11/14; G01J 1/04

(52) U.S. Cl. 356/614; 250/227.11

(57) ABSTRACT

An optical sensing system including a sensing plate, a light guiding device, and a detecting device is provided. The sensing plate has a light-pervious area. The light guiding device is disposed behind the sensing plate and used for reflecting an incident light proceeding along an incident direction, so as to form a first reflective light proceeding along a first direction and toward the light-pervious area. The incident direction is approximately perpendicular to the first direction. The detecting device is disposed behind the light guiding device. When an external surface of the light-pervious area is shaded by an object, the first reflective light is reflected by the object and forms a second reflective light proceeding toward the detecting device. Once receiving the second reflective light, the detecting device generates a sensing signal.

### BACKGROUND OF THE INVENTION

1. Field of the Invention

The present invention relates to optical sensing systems. In particular, the present invention relates to an optical sensing system can be used in human-machine interfaces.

2. Description of the Prior Art

With the advancement in science and technology, human-machine interfaces of many electronic products are more and more humanized in recent years. For instance, through a touch panel, users can directly input commands/characters/figures and control computer programs with their fingers instead of keyboards.

Existing touch sensing technologies can be roughly classified into the following categories: resistance type, capacitance type, electromagnetic induction type, ultrasonic type, and optical type. The sensing speed and resolution of resistance type and capacitance type touch panels are both high. However, the two types of touch panels have shorter lifetime if they are frequently pressed. Electromagnetic induction type touch panels are stable, accurate, sensitive, but quite expensive. Comparatively, ultrasonic and optical touch sensing technologies are suitable for large-size panels but have lower sensing speed. At the present time, resistance type and capacitance type touch panels are mostly used.

In a typical optical type touch panel, plural infrared transmitters and receivers are disposed around the panel. Interlaced infrared rays are formed by the transmitters. Once an object (for example, the finger of a user) touches a certain point on the panel, the infrared rays originally pass through the point are blocked and one or more corresponding receivers can no longer receive these infrared rays. According to the position of the receivers, the coordinates of the touched point can be found.

The US patent application with publication number 2008/0074401 discloses a different structure for an optical touch sensing display. In this application, infrared light sources are integrated in a backlight unit together with LEDs for providing red, green, and blue lights. Infrared rays are directly radiated from the backlight unit to the upper surface of the display. Once an object touches the upper surface, a portion of the infrared light is reflected back through transparent substrates and a transparent window. The reflected light is then detected by an infrared light-sensing transistor.

The disadvantage of the above structure is that if by any chance a small part of the infrared light sources or the LEDs is out of order, it is possible the whole backlight unit must be replaced. Besides, the manufacturing process of integrating various light sources is quite troublesome.

The US patent application with publication number 2008/0029691 discloses an optical touch sensing system utilizing frustrated total internal reflection (FTIR). In this system, light emitted from an infrared light source undergoes total internal reflection within an optical waveguide. When an object is placed in contact with a contact surface of the optical waveguide, total internal reflection is frustrated thus causing some light to scatter from the optical waveguide. The scattered light is then detected by an image sensor. One limitation of this structure is that the waveguide must be made of materials allowing TIR of infrared rays to occur therein.

### SUMMARY OF THE INVENTION

The invention provides a new structure for optical sensing systems. In systems according to this invention, an independent light source arranged as a side light can be used. The choices in type and size of the light source are both fairly flexible. In addition, the material of the light guiding device according to the invention is not particularly limited.

One embodiment according to the invention is an optical sensing system including a sensing plate, a light guiding device, and a detecting device. The sensing plate has a light-pervious area. The light guiding device is disposed behind the sensing plate and used for reflecting an incident light proceeding along an incident direction, so as to form a first reflective light proceeding along a first direction and toward the light-pervious area. The incident direction is approximately perpendicular to the first direction. The detecting device is disposed behind the light guiding device. When an external surface of the light-pervious area is shaded by an object, the first reflective light is reflected by the object and forms a second reflective light proceeding toward the detecting device. Once receiving the second reflective light, the detecting device generates a sensing signal.

The optical sensing system according to the invention can be widely utilized in electronic products such as touch sensing panels, touch sensing displays, and even computer mice controlled by touch sensing. The advantage and spirit of the invention may be understood by the following recitations together with the appended drawings.

### BRIEF DESCRIPTION OF THE APPENDED DRAWINGS

FIG. 1(A), FIG. 1(B) and FIG. 1(C) illustrate the cross-sectional view of the optical sensing system in the first embodiment according to the invention.

FIG. 2, FIG. 3(A), and FIG. 3(B) illustrate the optical sensing system in the second embodiment according to the invention.

FIG. 4 illustrates the optical sensing system in the third embodiment according to the invention.

FIG. 5 illustrates the optical sensing system in the fourth embodiment according to the invention.

FIG. 6(A) and FIG. 6(B) illustrates the optical sensing system in the fifth embodiment according to the invention.

FIG. 7 illustrates the vertical view of the detecting device in the sixth embodiment according to the invention.

FIG. 8(A) illustrates the cross-sectional view of the optical sensing system in the seventh embodiment according to the invention.

FIG. 8(B) illustrates the cross-sectional view of the optical sensing system in the eighth embodiment according to the invention.

FIG. 9(A), FIG. 9(B), and FIG. 9(C) illustrate the optical sensing system in the ninth embodiment according to the invention.

FIG. 10 illustrates the cross-sectional view of the optical sensing system in the tenth embodiment according to the invention.

FIG. 11 illustrates the cross-sectional view of the optical sensing system in the eleventh embodiment according to the invention.

### DETAILED DESCRIPTION OF THE INVENTION

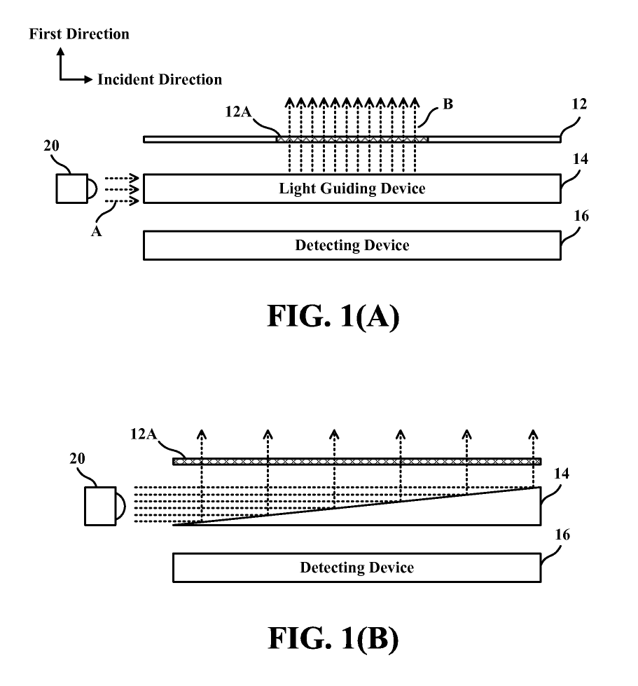

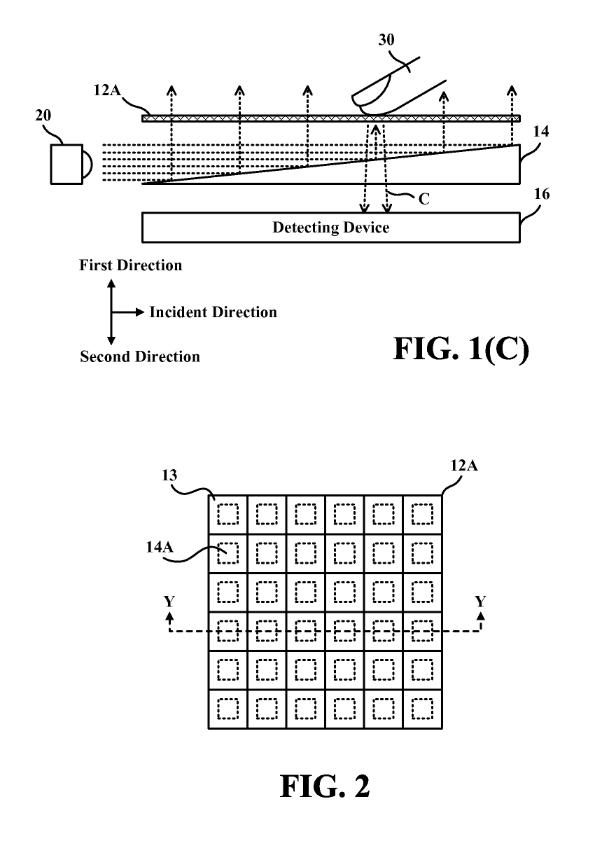

Please refer to FIG. 1(A), which illustrates the cross-sectional view of the optical sensing system in the first embodiment according to the invention. This optical sensing system includes a sensing plate 12 having a light-pervious area 12A, a light guiding device 14, and a detecting device 16. The light guiding device 14 disposed behind the sensing plate 12 is used for reflecting an incident light A, so as to form a first reflective light B projected toward the light-pervious area 12A.

In this embodiment, the incident light A is provided by a light source 20 disposed at one side of the light guiding device 14. As shown in FIG. 1(A), the incident light A proceeds along an incident direction, and the first reflective light B proceeds along a first direction approximately perpendicular to the incident direction. Practically, the incident light A can be either visible or invisible light. Hence, the light source 20 can be one or more LED bulbs, fluorescent lamps, or infrared ray generators, but not limited to these examples. In actual applications, the light source 20 can be integrated into the optical sensing system according to the invention.

FIG. 1(B) illustrates an exemplary light guiding device 14. In this example, the light guiding device 14 has an oblique reflecting surface. As long as the objective of generating the first reflective light B as shown in FIG. 1(A) is achieved, the reflecting surface can also be irregular. Since the height of the light guiding device 14 at the first direction gradually increases along the incident direction, the incident light A can be propagated to both sides of the light guiding device 14 closer to and farther from the light source 20.

The detecting device 16 is disposed behind the light guiding device 14. As shown in FIG. 1(C), when the external surface of the light-pervious area 12A is shaded by an object 30 (for example, a pen or the finger of a user), a portion of the first reflective light B that originally passes through the light-pervious area 12A at this point is blocked and reflected by the object 30. Accordingly, a second reflective light C proceeding toward the detecting device 16 is formed.

In this embodiment, the light guiding device 14 is designed so that light proceeding roughly along the second direction shown in FIG. 1(C) can penetrate through the light guiding device 14. The detecting device 16 according to the invention can include a CMOS image sensor or a CCD image sensor. Once receiving the second reflective light C, the detecting device 16 generates a sensing signal to indicate the light-pervious area 12A is touched or shaded. In response to this sensing signal, a microprocessor or other circuits can perform a corresponding operation, for instance, turning on/off a machine.

It is comprehensible that if the object 30 touches a different location in the light-pervious area 12A, the locality that the second reflective light C enters the detecting device 16 would be different as well. The detecting device 16 can further determine a relative position between the object 30 and the light-pervious area 12A based on the incident locality that the second reflective light C enters the detecting device 16.

Besides indicating whether the light-pervious area 12A is touched, the sensing signal generated by detecting device 16 can also include information about the time, frequency, and/or location the object 30 touches the light-pervious area 12A. Various operations corresponding to sensing signals with different contents can be defined by the circuit that receives the sensing signal with good flexibility. In addition, the light-pervious area 12A can be touched by more than one object 30 at the same time. By recording and analyzing the tracks/images detected by the detecting device 16, multi-touch function can also be implemented.

Please refer to FIG. 2 and FIG. 3(A). In the second embodiment according to the invention, the light guiding device 14 in the previous embodiment is replaced by M sets of smaller light guiding unit 14A, and the light-pervious area 12A is divided into M sensing regions 13. M is a positive integer larger than 1. Each set of light guiding unit 14A is corresponding to a sensing region 13. In actual applications, the number of the sensing regions 13 does not have to be the same as that of the sets of smaller light guiding unit 14A.

FIG. 2 illustrates an exemplary vertical view of this light-pervious area 12A. The light-pervious area 12A can be substantially transparent. According to the invention, the light-pervious area 12A can also be made to be light-pervious at only one side. Thereby, the M sets of light guiding unit 14A (represented by dashed lines) and other devices disposed behind the light-pervious area 12A are nearly invisible to users.

In this example, the light-pervious area 12A includes a 6×6 matrix of sensing regions 13. Correspondingly, 36 sets of light guiding unit 14A are also arranged in a matrix form. In actual applications, if the light-pervious area 12A is divided into an array of sensing regions 13, the light guiding units 14A can also be arranged in an array form.

FIG. 3(A) is the cross-sectional view of this optical sensing system along line Y-Y in FIG. 2. In this embodiment, the light guiding units 14A are wedge-shaped prisms. Each set of light guiding unit 14A is used for reflecting one part of the incident light, so as to form a part of the first reflective light proceeding toward the its corresponding sensing region. As shown in FIG. 3(A), along the incident direction, heights of the light guiding units 14A at the first direction are arranged to be gradually increased. Therefore, the incident light can be propagated even to the light guiding unit 14A farthest from the light source 20.

The detecting device 16 can also be divided into M detecting regions; each of the detecting regions is corresponding to a specific sensing region 13 in the light-pervious area 12A. As shown in FIG. 3(B), when a certain sensing region 13 is shaded by the object 30, the parts in the first reflective light that are projected to the shaded region 13 is reflected by the object 30 and forms a part of the second reflective light proceeding toward a corresponding detecting region in the detecting device 16. Once a specific detecting region detects the reflective light, the detecting device 16 generates a sensing signal to indicate the sensing region 13 corresponding to this detecting region is shaded.

In the above embodiment, it is not necessary to allow the reflected light proceeding along the second direction shown in FIG. 1(C) to penetrate through the light guiding units 14A. The reflected light can proceed to the detecting device 16 via the vacant spaces between the light guiding units 14A.

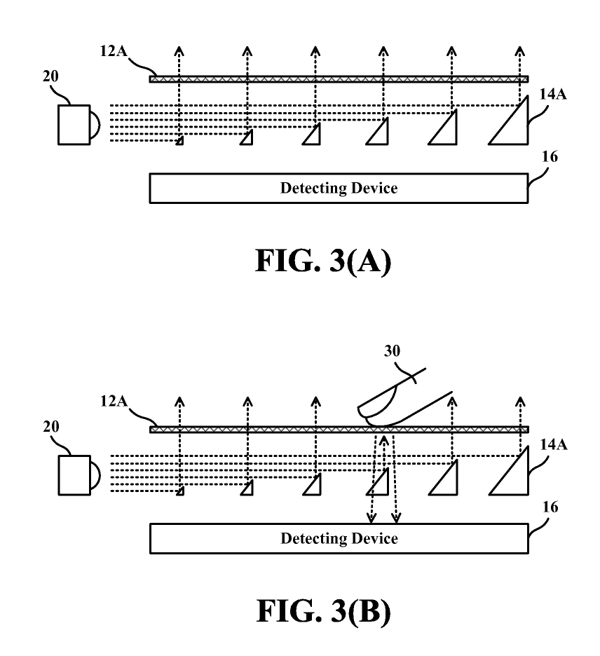

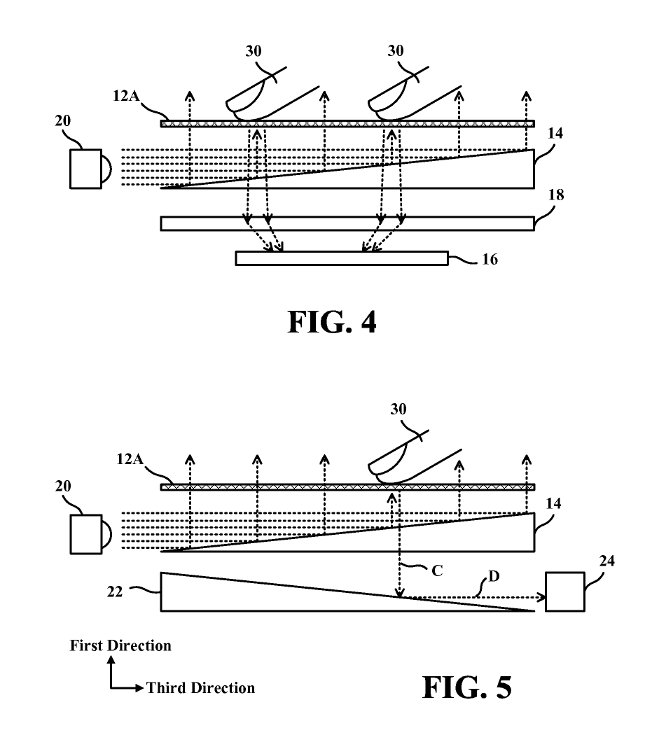

Please refer to FIG. 4, which illustrates the third embodiment according to the invention. The optical sensing system in this embodiment further includes a condensing lens 18 disposed between the light guiding device 14 and the detecting device 16. The condensing lens 18 is used for refracting the second reflective light. As long as lights reflected from different regions of the light-pervious area 12A are still distinguishable for the detecting device 16, the size of the detecting device 16 can be reduced.

FIG. 5 shows the fourth embodiment according to the invention. In this embodiment, the detecting device 16 includes a first reflecting unit 22 and a first detecting unit 24. The first reflecting unit 22 is used for reflecting the second reflective light C and forming a third reflective light D proceeding toward the first detecting unit 24. As shown in FIG. 5, the third reflective light D proceeds along a third direction approximately perpendicular to the first direction.

Also as shown in FIG. 5, the first reflecting unit 22 has an oblique reflecting surface in this example. As long as the objective of generating the third reflective light D as shown in FIG. 5 is achieved, the reflecting surface can also be irregular. Since the height of the first reflecting unit 22 at the first direction gradually decreases along the third direction, the third reflective light D can be propagated to the first detecting unit 24 from both sides of the first reflecting unit 22 closer to and farther from the first detecting unit 24.

Based on whether a third reflective light D exists, the first detecting unit 24 can judge whether the light-pervious area 12A is touched. Further, the first detecting unit 24 can also judge the relative position between the object 30 and the light-pervious area 12A according to the incident locality that the third reflective light D enters the first detecting unit 24. Taking the embodiment in FIG. 5 as an example, if the object 30 touches the left side of the light-pervious area 12A, the third reflective light D would enter the first detecting unit 24 at a higher point.

Same as the embodiment shown in FIG. 4, a condensing lens (not shown) can be added between the first reflecting unit 22 and the first detecting unit 24 in FIG. 5. Thereby, the first detecting unit 24 can be shrunk, so as to save the cost.

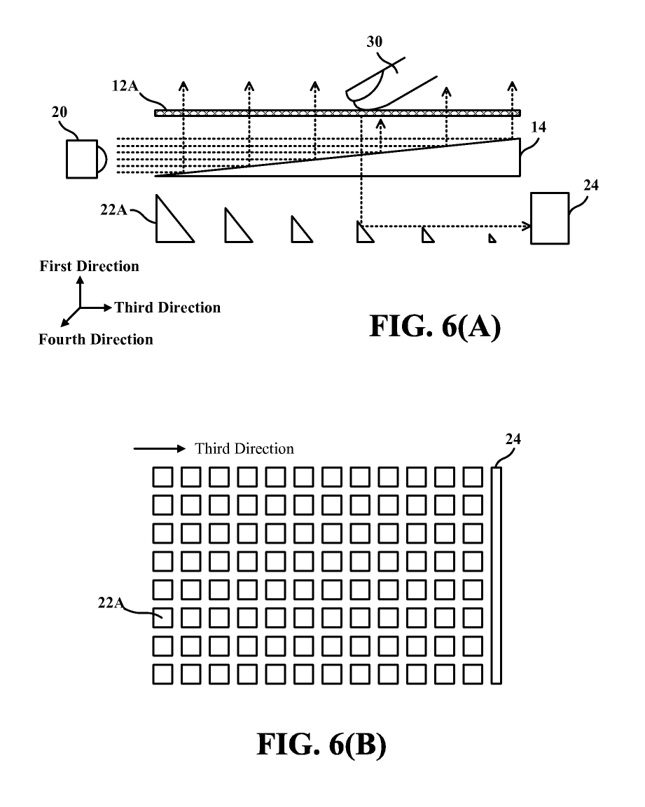

Please refer to FIG. 6(A), which illustrates the fifth embodiment according to the invention. It is an alternative embodiment of the system shown in FIG. 5. In this embodiment, the first reflecting unit 22 is replaced by a plurality of wedge-shaped reflectors 22A. The heights of the wedge-shaped reflectors 22A at the first direction are arranged to be gradually decreased. FIG. 6(B) is the vertical view of the wedge-shaped reflectors 22A and the first detecting unit 24.

In the sixth embodiment according to the invention, besides the first reflecting unit 22 and first detecting unit 24, the detecting device 16 further includes a second reflecting unit and a second detecting unit. The second reflecting unit is used for reflecting the second reflective light C and forming a fourth reflective light proceeding toward the second detecting unit. The fourth reflective light proceeds along a fourth direction approximately perpendicular to both the first direction and the third direction.

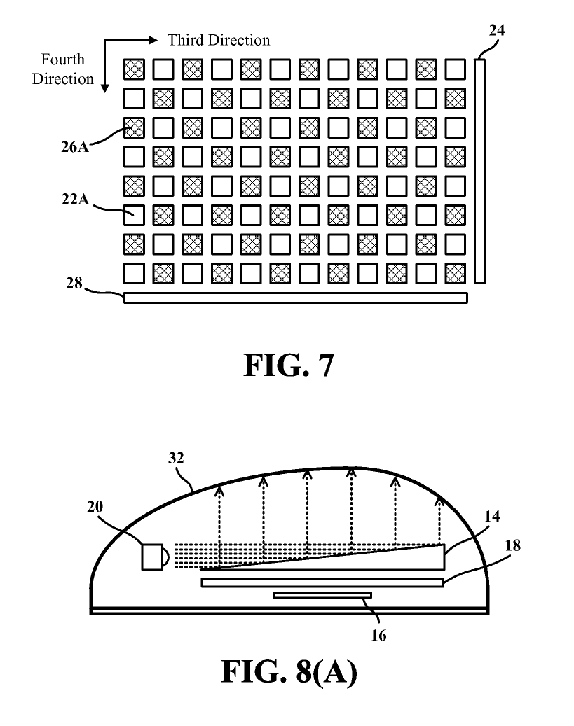

FIG. 7 illustrates the vertical view of the detecting device 16 in this embodiment. In this embodiment, the second reflecting unit also consists of a plurality of wedge-shaped reflectors 26A (shown as blocks with shadow). The wedge-shaped reflectors 22A (shown as blocks without shadow) and 26A are arranged in a crisscrossing pattern.

The height of the wedge-shaped reflectors 26A at the first direction gradually decreases along the fourth direction. The second detecting unit 28 is disposed to receive light propagating along the fourth direction. Similarly, the second detecting unit 28 can judge the relative position between the object 30 and the light-pervious area 12A according to the incident locality that the fourth reflective light enters the second detecting unit 28.

Same as the embodiment shown in FIG. 4, a condensing lens (not shown) can be added between the first detecting unit 24 and the wedge-shaped reflectors or between the second detecting unit 28 and the wedge-shaped reflectors in FIG. 7. Thereby, the first detecting unit 24 and the second detecting unit 28 can be shrunk, so as to save the cost.

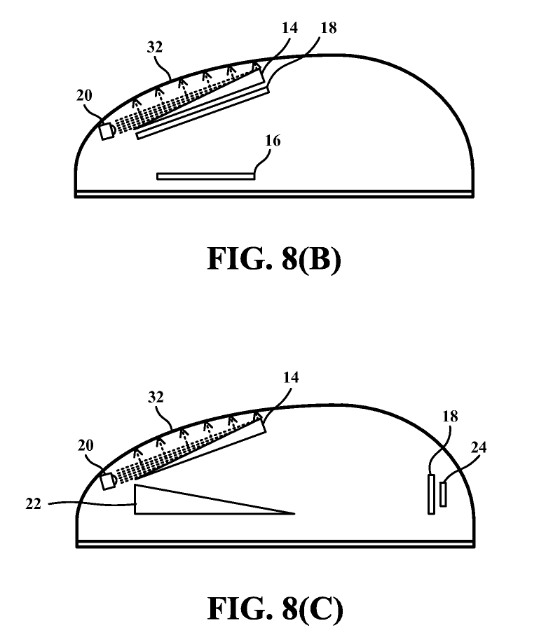

FIG. 8(A) illustrates the cross-sectional view of the optical sensing system in the seventh embodiment according to the invention. The sensing plate 32 in this embodiment is a curved surface instead of a flat plate. This curved surface can be either regular or irregular. Light projected from the light guiding device 14 can also be reflected by objects touching the sensing plate 32. The detecting device 16 is also capable of judging the relative position between the objects and the sensing plate 32 based on the incident locality that the reflective light enters the detecting device 16 via the condensing lens 18.

FIG. 8(B) illustrates the cross-sectional view of the optical sensing system in the eighth embodiment according to the invention. The light source 20, light guiding device 14, detecting device 16, and the condensing lens 18 in this embodiment are relatively smaller than the system. This kind of architecture is especially suitable for applications with smaller optical sensing region. As shown in FIGS. 8(A) and 8(B), as long as appropriate device sizes and assembling locations are selected, the idea according to the invention can also be applied in conditions of curved sensing plates 32, such as in a touch-sensing mouse.

FIG. 8(C) illustrates another exemplary arrangement of the optical sensing system according to the invention. In this example, the detecting device 16 in FIG. 8(B) is replaced by the first reflecting unit 22 and first detecting unit 24 in FIG. 5. As shown in FIG. 8(C), the condensing lens 18 and the first detecting unit 24 are disposed at the rear part of the mouse.

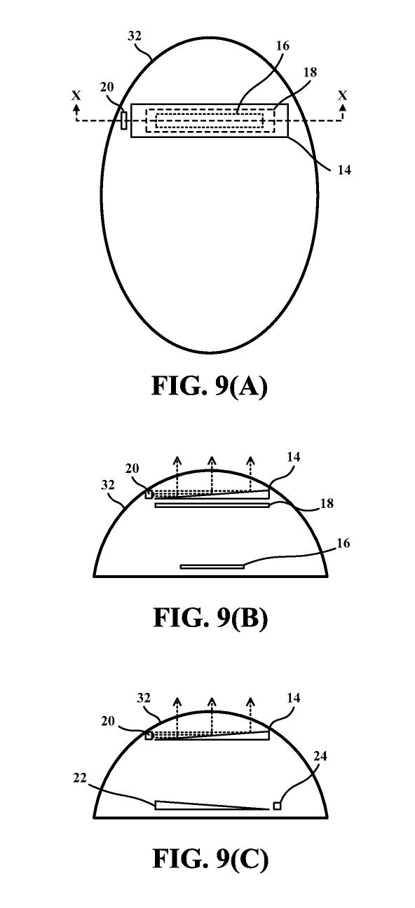

FIG. 9(A) is the vertical view of the optical sensing system in the ninth embodiment according to the invention. FIG. 9(B) is the cross-sectional view of this optical sensing system along line X-X in FIG. 9(A). The main difference between this embodiment and the previous embodiment is the positions of the light source 20, light guiding device 14, detecting device 16, and the condensing lens 18 relative to the sensing plate 32. As shown in FIG. 9(C), the detecting device 16 can be replaced by the first reflecting unit 22 and first detecting unit 24 in FIG. 5. The same optical sensing effect can still be achieved.

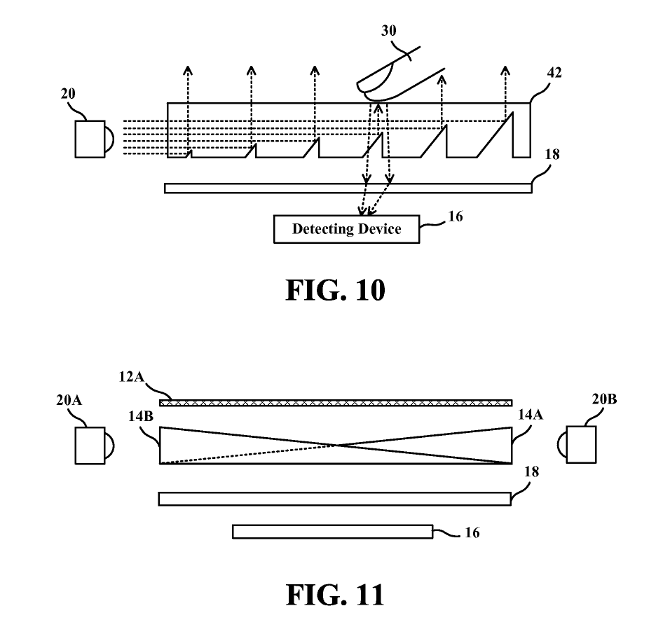

FIG. 10 illustrates the cross-sectional view of the optical sensing system in the tenth embodiment according to the invention. In this embodiment, the sensing plate and the light guiding device are integrated. As shown in FIG. 10, the upper surface of sensing plate 42 is a flat surface, and plural wedge-shaped gaps are formed on its lower surface. The slide surfaces of the gaps that face the light source 20 are used for reflecting lights provided the light source 20. The optical sensing effect can also be achieved in this architecture.

FIG. 11 illustrates the cross-sectional view of the optical sensing system in the eleventh embodiment according to the invention. The system in this embodiment includes a first light source 20A and a second light source 20B respectively disposed at two different sides. The incident directions of the lights provided by the two light sources are opposite to each other. A first light guiding unit 14A is used for reflecting a first incident light provided by the first light source 20A. A second light guiding unit 14B is used for reflecting a second incident light provided by the second light source 20B. As shown in the figure, both reflective lights formed by the first light guiding unit 14A and the second light guiding unit 14B proceed toward the light-pervious area 12A. Practically, this system can include plural interlaced first light guiding units 14A and the second light guiding units 14B. The two schemes can both provide the optical sensing effect as the previous embodiments.

As described above, the invention provides new structures for optical sensing systems. In systems according to this invention, an independent light source arranged as a side light can be used. Thus, the choices in type and size of the light source are fairly flexible. In addition, the material of the light guiding device according to the invention is not particularly limited. The optical sensing systems according to the invention can be widely utilized in electronic products such as touch sensing panels, touch sensing displays, and even computer mice controlled by touch sensing.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An optical sensing system, comprising:
a sensing plate having a light-pervious area;
a light guiding device, disposed behind the sensing plate, for reflecting an incident light proceeding along an incident direction, so as to form a first reflective light proceeding along a first direction and toward the light-pervious area, the incident direction being approximately perpendicular to the first direction; and
a detecting device disposed behind the light guiding device, when an external surface of the light-pervious area is shaded by an object, the first reflective light being reflected by the object and forming a second reflective light proceeding toward the detecting device, once receiving the second reflective light, the detecting device generating a sensing signal.

2. The optical sensing system of claim 1, wherein a height of the light guiding device at the first direction gradually increases along the incident direction.

3. The optical sensing system of claim 1, wherein the light guiding device comprises at least one wedge-shaped prism.

4. The optical sensing system of claim 1, wherein the detecting device judges a relative position between the object and the light-pervious area according to an incident locality that the second reflective light enters the detecting device.

5. The optical sensing system of claim 1, wherein the light guiding device comprises M sets of light guiding unit, M is a positive integer larger than 1, an ith set light guiding unit among the M sets of light guiding unit is used for reflecting an ith part in the incident light, so as to form an ith part in the first reflective light, i being an integer index ranging from 1 to M.

6. The optical sensing system of claim 5, wherein the M sets of light guiding unit are arranged in a matrix form or an array form.

7. The optical sensing system of claim 5, wherein along the incident direction, heights of the M sets of light guiding unit at the first direction are arranged to be gradually increased.

8. The optical sensing system of claim 5, wherein when the object reflects the ith part in the first reflective light, an ith part in the second reflective light proceeding toward an ith detecting region of the detecting device is formed, once the ith detecting region detects the ith part in the second reflective light, the detecting device generates the sensing signal.

9. The optical sensing system of claim 1, wherein the first reflective light is a visible light or an invisible light.

10. The optical sensing system of claim 1, wherein the detecting device comprises a CMOS image sensor or a CCD image sensor.

11. The optical sensing system of claim 1, further comprising:
a light source, disposed at one side of the light guiding device, for providing the incident light.

12. The optical sensing system of claim 1, further comprising:
a condensing lens, disposed between the light guiding device and the detecting device, for refracting the second reflective light.

13. The optical sensing system of claim 1, wherein the detecting device comprises a first reflecting unit and a first detecting unit, the first reflecting unit is used for reflecting the second reflective light and forming a third reflective light proceeding toward the first detecting unit, the first detecting unit judges a first relative position between the object and the light-pervious area according to a first incident locality that the third reflective light enters the first detecting unit.

14. The optical sensing system of claim 13, wherein the third reflective light proceeds along a third direction approximately perpendicular to the first direction.

15. The optical sensing system of claim 14, wherein a height of the first reflecting unit at the first direction gradually decreases along the third direction.

16. The optical sensing system of claim 13, wherein the detecting device further comprises a second reflecting unit and a second detecting unit, the second reflecting unit is used for reflecting the second reflective light and forming a fourth reflective light proceeding toward the second detecting unit, the second detecting unit judges a second relative position between the object and the light-pervious area according to a second incident locality that the fourth reflective light enters the second detecting unit.

17. The optical sensing system of claim 16, wherein the second reflective light proceeds along a second direction, the third reflective light proceeds along a third direction, the fourth reflective light proceeds along a fourth direction, the second direction is approximately perpendicular to the third direction, and the fourth direction is approximately perpendicular to both the second direction and the third direction.

18. The optical sensing system of claim 17, wherein a height of the second reflecting unit at the first direction gradually decreases along the fourth direction.

19. An optical sensing system, comprising:
a light guiding device having a light-pervious area, the light guiding device being used for reflecting an incident light proceeding along an incident direction, so as to form a first reflective light proceeding along a first direction and toward the light-pervious area, the incident direction being approximately perpendicular to the first direction; and
a detecting device disposed behind the light guiding device, when an external surface of the light-pervious area is shaded by an object, the first reflective light being reflected by the object and forming a second reflective light proceeding toward the detecting device, once receiving the second reflective light, the detecting device generating a sensing signal.

20. The optical sensing system of claim 19, wherein the height of a reflective portion of the light guiding device at the first direction gradually increases along the incident direction.

21. An optical sensing system, comprising:
a sensing plate having a light-pervious area;
a first light source for providing a first incident light proceeding along a first incident direction;
a second light source for providing a second incident light proceeding along a second incident direction, the first incident direction being approximately opposite to the second incident direction;
P first light guiding units disposed behind the sensing plate, P being a positive integer, each of the first light guiding units respectively reflecting the first incident light, so as to form a first reflective light proceeding along a first direction and toward the light-pervious area, the first direction being approximately perpendicular to the first incident direction;
N second light guiding units disposed behind the sensing plate, N being a positive integer, each of the second light guiding units respectively reflecting the second incident light, so as to form a second reflective light proceeding along the first direction and toward the light-pervious area; and
a detecting device disposed behind the P first light guiding units and the N second light guiding units, when an external surface of the light-pervious area is shaded by an object, the first reflective light or the second reflective light being reflected by the object, a third reflective light proceeding toward the detecting device being accordingly formed, once receiving the third reflective light, the detecting device generating a sensing signal.

22. The optical sensing system of claim 21, wherein the P first light guiding units and the N second light guiding units are interlaced.
